(19) United States
(12) Patent Application Publication
(10) Pub. No.: US 2023/0092611 A1
(43) Pub. Date: Mar. 23, 2023

(54) SYSTEMS AND METHODS FOR VEHICLE AIR AND HUMIDITY REGULATION BASED ON TEAR FILM MONITORING

(71) Applicant: TOYOTA MOTOR ENGINEERING & MANUFACTURING NORTH AMERICA, INC., Plano, TX (US)

(72) Inventor: John C. Rafferty, Dexter, MI (US)

(21) Appl. No.: 17/481,779

(22) Filed: Sep. 22, 2021

(51) Int. Cl. B60H 1/00

(52) U.S. Cl. CPC B60H 1/00742; B60H 1/00828; B60H 1/00871

(57) ABSTRACT

Systems and methods for vehicle air and humidity regulation based on tear film monitoring are provided. A vehicle system may include a camera configured to capture one or more images of a vehicle occupant. A logic device may be configured to detect a tear film breakup of the vehicle occupant based on the one or more images captured by the camera. An air system module configured to identify an air system setting adjustment based on the tear film breakup detected by the logic device. A heating, ventilation, and air condition (HVAC) system may be configured to adjust an air system setting of the vehicle based on the air system setting adjustment. Associated methods are also provided.

### TECHNICAL FIELD

The present disclosure relates generally to vehicle air and humidity regulation, and, more particularly, to systems and methods for vehicle air and humidity regulation based on tear film monitoring.

### BACKGROUND

Vehicles that use air conditioning may cause individuals in the vehicle to develop dry eyes due to moisture being removed from the air in the vehicle. Dry eyes may lead to eye fatigue, which may impair driver performance. Current vehicles cannot sense whether an individual is experiencing dryness of the eyes, nor can current vehicles regulate vehicle air and humidity based on such a detection of dry eyes.

### BRIEF SUMMARY

The present disclosure provides systems and methods for vehicle air and humidity regulation based on tear film monitoring. For example, systems and methods are provided that monitor vehicle passengers for tear film breakup and automatically adjust airflow and other air system settings to limit or reduce eye dryness.

Various embodiments of the present disclosure include a vehicle system. The vehicle system may include a camera configured to capture one or more images of a vehicle occupant, a logic device configured to detect a tear film breakup of the vehicle occupant based on the one or more images captured by the camera, and an air system module configured to identify an air system setting adjustment based on the tear film breakup detected by the logic device.

Various embodiments of the present disclosure include a vehicle. The vehicle may include a camera configured to capture one or more images of a vehicle occupant, a logic device configured to detect an eye condition of the vehicle occupant based on the one or more images captured by the camera, and a heating, ventilation, and air condition (HVAC) system configured to adjust an air system setting of the vehicle based on the eye condition detected by the logic device.

Various embodiments of the present disclosure include a method of reducing tear film breakup of a vehicle occupant. The method may include capturing, using a camera, one or more images of an occupant of a vehicle, detecting a tear film breakup of the occupant based on the one or more images captured by the camera, and adjusting an air system setting of the vehicle based on the detecting the tear film breakup of the occupant.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

Aspects of the present disclosure are best understood from the following detailed description when read with the accompanying figures.

FIG. 1 is an illustration of a vehicle system configured to monitor eye dryness of one or more occupants of a vehicle, according to one or more embodiments of the disclosure.

FIG. 2 is an illustration of a decision structure of a vehicle air and humidity regulation system, according to one or more embodiments of the disclosure.

FIG. 3 is a flowchart of a method of regulating air and humidity of a vehicle, according to one or more embodiments of the disclosure.

FIG. 4 is a diagram illustrating an example computing or processing system, according to one or more embodiments of the disclosure.

### DETAILED DESCRIPTION

The present disclosure provides systems and methods for vehicle air and humidity regulation based on tear film monitoring. Tear film is a protective film consisting of lipids, water, and mucin that coats the outer surface of the eye, lubricating and maintaining the healthy functioning of the eye. A breakup or decrease of tear film (i.e., tear film breakup) may lead to eye dryness, expose the eye to external irritants, reduce supply of nutrients to the eye, lead to infection, decrease healing, and/or cause vision issues, among other issues. Tear film breakup may be caused from various conditions. For example, air dryness (low humidity) or direct air impingement, such as from a heating, ventilation, and air condition (HVAC) system, may deteriorate the tear film, such as caused by evaporation. Tear film stability can be assessed via a number of tools. For instance, a determination of tear film breakup may be based on the reflectivity of the eye, such as a matte eye finish indicating tear film breakup, with a reflective eye finish indicating a sufficient tear film. Supplemental factors may also be considered. For example, capillary action in the eye (e.g., eye redness or irritation) may support a finding of tear film breakup.

In embodiments, a vehicle system may include a camera configured to capture one or more images of a vehicle occupant. A logic device may be configured to detect a tear film breakup of the vehicle occupant based on the one or more images captured by the camera. An air system module configured to identify an air system setting adjustment based on the tear film breakup detected by the logic device. An HVAC system may be configured to adjust an air system setting of the vehicle based on the air system setting adjustment. Associated methods are also provided.

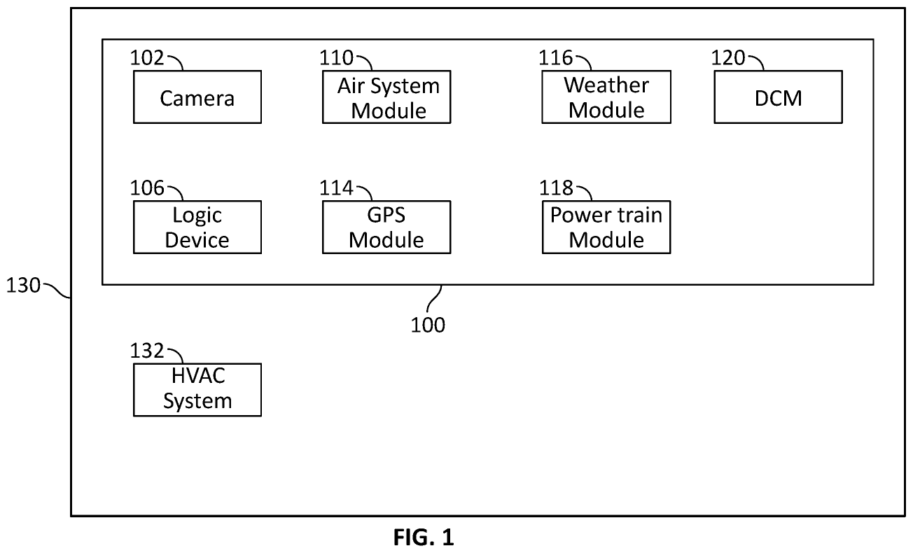

FIG. 1 is an illustration of a vehicle system 100 configured to monitor eye dryness of one or more occupants of a vehicle, according to one or more embodiments of the disclosure. Referring to FIG. 1, the vehicle system 100 may include one or more features, modules, or subsystems configured to monitor one or more vehicle occupants (e.g., driver, passengers) for tear film breakup and automatically adjust an air system setting (e.g., airflow, humidity, etc.) of the vehicle to limit or reduce eye dryness of the one or more vehicle occupants. For example, the vehicle system 100 may continuously monitor the tear film of the one or more vehicle occupants and dynamically adjust the vehicle's air system accordingly.

As shown, the vehicle system 100 may include a camera 102 (e.g., a single camera or multiple cameras) for detecting tear film breakup of the one or more vehicle occupants. For instance, the camera 102 may be configured to capture one or more images of a vehicle occupant to measure tear film breakup indicative of dry eyes. The camera 102 may include at least one of a driver monitoring camera, a passenger monitoring camera, or the like. The camera 102 may be capable of tracking the eyes of the vehicle occupant, such as to allow for occupant movement or various positioning of the occupant within the vehicle. In embodiments, the vehicle system 100 may utilize an existing camera in the vehicle, such as an existing camera configured to monitor vehicle occupants for additional reasons, such as fatigue, distracted driving, or the like. In other embodiments, the camera 102 may be a special purpose camera designed for monitoring tear film breakup only. The camera 102 may be an infrared (IR) camera, a visible light spectrum camera, a full spectrum camera, an ultraviolet camera, or the like.

With continued reference to FIG. 1, the vehicle system 100 may include a logic device 106 configured to detect tear film breakup of a vehicle occupant based on one or more images captured by the camera 102. The logic device 106 may be any controller, processor, module, circuitry, or device configured to perform one or more operations. The logic device 106 may be implemented as any appropriate controller (e.g., processing device, microcontroller, electronic control unit, processor, application specific integrated circuit (ASIC), field programmable gate array (FPGA), memory storage device, memory reader, or other device or combinations of devices) that may be adapted to execute, store, and/or receive appropriate instructions, such as software instructions for controlling various operations of the vehicle system 100, for example. Such software instructions may also implement methods for processing images and/or other sensor signals or data, determining sensor information, providing user feedback (e.g., through a user interface), querying devices for operational parameters, selecting operational parameters for devices, or performing any of the various operations described herein (e.g., operations performed by logic devices of various devices of vehicle system 100).

The logic device 106 may analyze the image(s) captured by the camera 102 to determine if a vehicle occupant is experiencing tear film breakup, such as caused by insufficient production of tears or excessive tear evaporation resulting from air system settings of the vehicle (e.g., excessive fan speed, low humidity, direct airflow onto the eyes of the vehicle occupant, etc.). In embodiments, the logic device 106 may analyze the camera image(s) to identify or detect a reflectivity of the vehicle occupant's eye. For instance, the logic device 106 may analyze the camera image(s) to identify or detect a matte finish of the eye, indicative of dry eyes, or a reflective finish of the eye, indicative of sufficient tear film. In some embodiments, the logic device 106 may analyze the camera image(s) to identify or detect a capillary action in the vehicle occupant's eye. For example, the logic device 106 may be configured to detect eye redness or irritation, which may also be indicative of dry eyes resulting from tear film breakup.

In embodiments, the logic device 106 may monitor, through the camera 102, whether tear film breakup or capillary action exceeds a threshold level, such as above a preset threshold. If tear film breakup or capillary action exceed the threshold level, the logic device 106 may determine that eye dryness is occurring. Alternatively, if tear film breakup or capillary action is below the threshold level, the logic device 106 may determine that eye dryness is not occurring. In embodiments, the threshold level may be adjusted by a user (e.g., the driver or passenger, a vehicle technician, etc.) to achieve a desired result, such as to increase or decrease the sensitivity of the vehicle system 100 as desired (e.g., to suit a particular vehicle occupant). In embodiments, the threshold level may be adjusted automatically or dynamically (e.g., by the logic device 106 itself), such as via a machine learning algorithm, updates to the system/algorithm, user feedback, etc. In such embodiments, the logic device 106 may intelligently determine whether tear film breakup exists

Continuing to refer to FIG. 1, the vehicle system 100 may include an air system module 110 configured to identify an air system setting adjustment based on the tear film breakup detected by the logic device 106. The air system module 110 may identify one or more adjustments to make to a heating, ventilation, and air condition (HVAC) system of the vehicle to reduce or limit tear film breakup. For instance, the air system module 110 may identify one or more adjustments to air modes, speeds, and other systems of the vehicle upon detection of tear film breakup. The adjustment(s) identified by the air system module 110 may include any combination of a reduction of fan speed, a reduction of air conditioning, or an increase of humidity. Increasing the humidity within the vehicle may be realized by modifying a recirculation mode of the HVAC system, such as recirculation deactivation or activation. In some embodiments, the adjustment(s) identified by the air system module 110 may include an adjustment of at least one window of the vehicle, such as rolling up or down one or more windows, to modify airflow within the vehicle. In some embodiments, the adjustment(s) identified by the air system module 110 may include a redirection of airflow away from the vehicle occupant experiencing tear film breakup or a redirection of airflow towards the vehicle occupant experiencing tear film breakup (e.g., a redirection of added humidity to the vehicle occupant experiencing tear film breakup).

As shown in FIG. 1, the vehicle system 100 may include other components or modules. For instance, the vehicle system 100 may include a global positioning system (GPS) module 114 for determining a position or location of the vehicle. The air system setting adjustment may be identified based on the location of the vehicle. For example, the adjustment(s) may account for, and be dynamically adjusted based on, vehicle speed or locale-specific characteristics (e.g., local traffic, construction, allergen levels, etc.).

Additionally, or alternatively, the vehicle system 100 may include a weather module 116 configured to acquire vehicle location weather data. The air system setting adjustment may be identified based on the weather data. For instance, the adjustment(s) may account for, and be dynamically adjusted based on, locale-specific weather conditions. For example, the air system module 110 may not recommend rolling down the windows when it is raining or snowing outside or at certain exterior temperatures (e.g., hot temperatures, freezing temperatures, etc.).

In some embodiments, the vehicle system 100 may include a powertrain module 118 configured to determine a vehicle economy. For instance, the powertrain module 118 may determine vehicle efficiency (e.g., miles per gallon), predicted range, distance to travel, or the like. The air system setting adjustment may be identified based on the vehicle economy. For example, adjustments to air conditioning or window position may account for powertrain demands and economy goals.

In embodiments, the vehicle system 100 may include a data communication module (DCM) 120 facilitating communication between the various modules of vehicle system 100. For example, the DCM 120 may allow the vehicle system 100 to communicate with off-board modules, mobile networks, and/or the internet. Specifically, one or more of the GPS module 114, weather module 116, or powertrain module 118 may be off-board.

As described herein, the vehicle system 100 may be implemented as part of a vehicle 130 (e.g., a car, SUV, truck, or the like). In such embodiments, the vehicle 130 may include an HVAC system 132. The HVAC system 132 may be configured to adjust an air system setting of the vehicle 130 based on the air system setting adjustment identified by the air system module 110. For instance, the HVAC system 132 may reduce fan speed, reduce air conditioning, add humidity, adjust the recirculation mode, redirect airflow within the cabin, or any combination thereof, based on a control signal received from the air system module 110. Depending on the application, the air system module 110 may be integrated with the HVAC system 132 or may be a module separate from the HVAC system 132.

Although described above with reference to tear film breakup, the vehicle system 100 may be configured to identify or detect other eye conditions of the vehicle occupant. For example, the logic device 106 may be configured to detect an indication of an allergic reaction of the vehicle occupant based on the one or more images captured by the camera 102. For instance, an allergic reaction may cause tearing of the vehicle occupant, which may be identified via a highly reflective finish of the eye through the camera 102. In such embodiments, the HVAC system 132 may be adjusted to reduce allergens within the cabin. For example, the vehicle system 100 may close vehicle windows (if open), activate recirculation (if turned off), and/or activate a particle filter (if turned off), or any combination thereof.

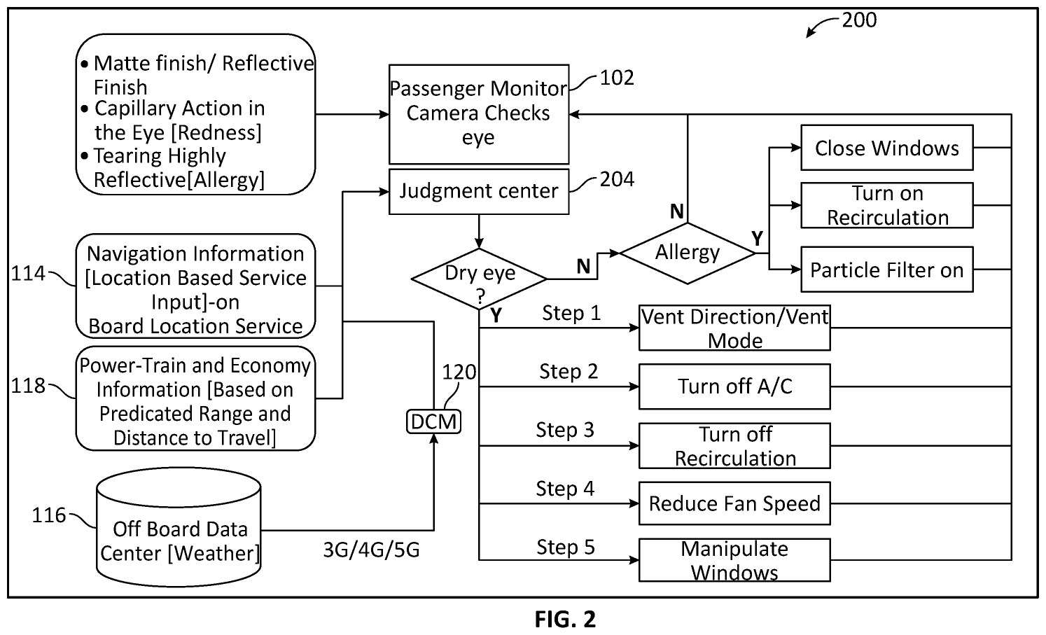

FIG. 2 is an illustration of a decision structure 200 of a vehicle air and humidity regulation system (e.g., vehicle system 100), according to one or more embodiments of the disclosure. Referring to FIG. 2, the camera 102 may continuously monitor the tear film of at least one vehicle occupant (e.g., at least the driver, driver and passengers, etc.), looking for eye finish (e.g., matte finish, reflective finish, highly reflective finish, etc.), capillary action (e.g., redness), or any combination thereof.

A judgment center 204 may utilize the camera data to determine whether the vehicle occupant is experiencing dry eyes. For example, judgment center 204 may include logic device 106, described above. If judgment center 204 (e.g., via logic device 106) determines the vehicle occupant is experiencing dry eyes, the decision structure 200 may determine an air system setting adjustment to reduce or limit additional tear film breakup. For instance, judgment center 204 may include air system module 110, described above. The judgment center 204 (e.g., via air system module 110) may determine any combination of the following air system setting adjustments to reduce or limit tear film breakup: ventilation direction, ventilation mode/zone, air conditioning deactivation, recirculation deactivation, fan speed reduction, or window manipulation. Depending on the application, the air system setting adjustments may be made in steps (e.g., based on a hierarchy). For example, judgment center 204 may first decide to adjust ventilation direction and mode, such as redirecting airflow towards/away from the vehicle occupant experiencing dry eyes (Step 1). If Step 1 is insufficient in reducing tear film breakup, judgment center 204 may then decide to take further action in a continuous feedback loop, such as turning off air conditioning (Step 2), turning off recirculation (Step 3), reducing fan speed (Step 4), and manipulating windows (Step 5). The above steps are exemplary only, and the decision structure 200 may include other steps, and/or the steps may be arranged in a different order.

If judgment center 204 (e.g., via logic device 106) determines the vehicle occupant is not experiencing dry eyes, the decision structure 200 may then determine whether the vehicle occupant is experiencing an allergic reaction. If judgment center 204 (e.g., via logic device 106) determines the vehicle occupant is experiencing allergies, the decision structure 200 may determine an air system setting adjustment to reduce or limit allergens within the cabin, such as any combination of the following air system setting adjustments: close windows, turn on recirculation, or activate particle filter. The above adjustments may be made in steps, in any order, and reanalyzed in a continuous feedback loop. If judgment center 204 determines the vehicle occupant is not experiencing allergies, the decision structure 200 returns to continuously monitoring the tear film of at least one vehicle occupant via camera 102.

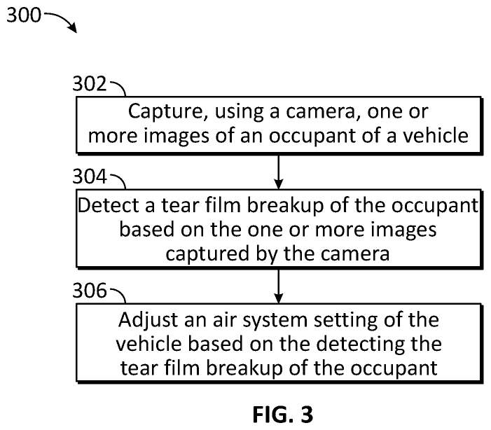

FIG. 3 is a flowchart of a method 300 of regulating air and humidity of a vehicle, according to one or more embodiments of the disclosure. Method 300 may be implemented using various systems and decision trees, such as vehicle system 100 and decision structure 200 described above. Method 300 is illustrated as a set of operations or steps and is described with reference to FIGS. 1-2, although method 300 may be applied to other embodiments not illustrated in FIGS. 1-2. One or more steps that are not expressly illustrated in FIG. 3 may be included before, after, in between, or as part of the illustrated steps.

In block 302, method 300 includes capturing one or more images of an occupant of a vehicle. For example, a driver or passenger monitoring camera (e.g., camera 102, described above) may continuously monitor the vehicle occupant, and in particular, the eyes of the vehicle occupant. In embodiments, the one or more images of the occupant may be captured using an infrared camera.

In block 304, method 300 includes detecting a tear film breakup of the occupant based on the one or more images captured by the camera. Block 304 may include detecting at least one of a capillary action in an eye of the occupant or a reflectivity of the eye of the occupant. For example, using infrared light, a logic device may determine whether the occupant is experiencing redness, irritation, or other symptoms of dry eyes (e.g., matte eye finish, etc.), as explained above.

In block 306, method 300 includes adjusting an air system setting of the vehicle based on the detecting the tear film breakup of the occupant. Block 306 may include at least one of turning off air conditioning, turning off a recirculation mode, or reducing a fan speed of an HVAC system of the vehicle. In some embodiments, block 306 may include adjusting a ventilation direction and/or mode/zone of the HVAC system. In some embodiments, block 306 may include manipulating at least one window of the vehicle to modify airflow within the vehicle cabin.

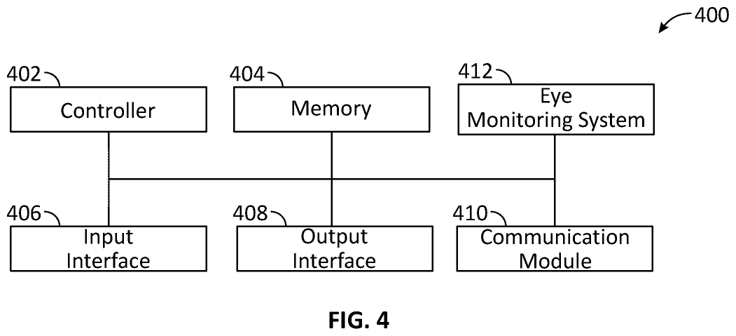

FIG. 4 is a diagram illustrating an example computing or processing system 400 in which embodiments of the present disclosure may be implemented. For example, vehicle system 100, as described above, may be implemented using system 400. In some embodiments, method 300 of FIG. 3, as described above, may be implemented using system 400. Computing or processing system 400 can be or include a computer or any other type of computing device. Such an electronic device includes various types of computer readable media and interfaces for various other types of computer readable media. As shown in FIG. 4, system 400 includes a controller 402, a memory 404, an input interface 406, an output interface 408, and a communications module 410.

The controller 402, according to various embodiments, includes one or more of a processor, a microprocessor, a central processing unit (CPU), an electronic control unit, a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device that may be configured, by hardwiring, executing software instructions, or a combination of both, to perform various operations discussed herein for embodiments of the disclosure. The controller 402 may be configured to interface and communicate with the various other components of the processing system 400 to perform such operations. For example, the controller 402 may be configured to receive and process map, position, weather, eye monitoring, and vehicle data, among others, received from a network and/or one or more sensors (e.g., camera 102, etc.), store the data in the memory 404, and/or retrieve stored data from the memory 404.

The controller 402 may include combinations of hardware and software processing functionality and may be provided with/in and/or communicatively attached to other components to execute appropriate instructions, such as software instructions and/or processing parameters stored in the memory 404. In various embodiments, the controller 402 may be configured to execute software instructions stored in the memory 404 to perform various methods, processes, or operations in the manner described herein.

The memory 404 includes, in one embodiment, one or more memory devices configured to store data and information, including magnetic flux data and position information. The memory 404 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the controller 402 may be configured to execute software instructions stored in the memory 404 to perform method 300 and process steps and/or operations. The controller 402 may be configured to store data in the memory 404.

The input interface 406 includes, in one embodiment, a user input and/or an interface device, such as one or more knobs, buttons, slide bars, keyboards, sensors, cameras, and/or other devices, that are adapted to generate an input control signal. The controller 402 may be configured to sense the input control signals from the input interface 406 and respond to any sensed input control signals received therefrom. The controller 402 may be configured to interpret such an input control signal as a value, as generally understood by one skilled in the art. In one embodiment, the input interface 406 may include a control unit (e.g., a wired or wireless handheld control unit) having push buttons adapted to interface with a user and receive user input control values. In one implementation, the push buttons of the control unit may be used to control various system functions.

The output interface 408 may enable, for example, the output of data or other information. The output interface 408 may include, for example, one or more display devices, such as monitors or other visual displays (e.g., light emitting diode (LED) displays, liquid crystal displays (LCDs), head-up displays (HUDs), or other types of displays). Some implementations include devices such as a touchscreen that function as both input and output components. The controller 402 may be configured to render data and information on the output interface 408. For example, the controller 402 may be configured to render data on the output interface 408, such as data stored in the memory 404.

In some embodiments, various components of system 400 may be distributed and in communication with one another over a network. In this regard, system 400 may include a communications module 410 configured to facilitate wired and/or wireless communication among various system components over the network. Such a network may include, for example, a local area network (“LAN”), such as an Intranet, a wide area network (“WAN”), such as the Internet, or a cellular network (e.g., 3G/4G/5G).

As shown, system 400 may include eye monitoring system 412. Eye monitoring system 412 may be similar to vehicle system 100, described above. For example, the eye monitoring system 412 may include one or more sensors or cameras configured to sense, acquire, monitor, or otherwise determine a tear film breakup of a vehicle occupant, such as the driver and/or other passenger.

In some embodiments, various components of system 400 may be communicatively connected via a system communications bus 414. Bus 414 collectively represents all system, peripheral, and chipset buses that communicatively connect the numerous devices of system 400. For instance, bus 414 may communicatively connect controller 402, memory 404, input interface 406, output interface 408, communication module 410, and eye monitoring system 412 together.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

While certain exemplary embodiments of the invention have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art. The intention is to cover all modifications, equivalents and alternatives falling within the spirit and scope of the disclosure as defined by the claims.

For example, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments. In addition, while different steps, processes, and procedures are described as appearing as distinct acts, one or more of the steps, one or more of the processes, and/or one or more of the procedures may also be performed in different orders, simultaneously, and/or sequentially. In some embodiments, the steps, processes, and/or procedures may be merged into one or more steps, processes, and/or procedures. In some embodiments, one or more of the operational steps in each embodiment may be omitted.

What is claimed is:

1. A vehicle system comprising:
a camera configured to capture one or more images of a vehicle occupant;
a logic device configured to detect a tear film breakup of the vehicle occupant based on the one or more images captured by the camera; and
an air system module configured to identify an air system setting adjustment based on the tear film breakup detected by the logic device.

2. The vehicle system of claim 1, wherein the air system setting adjustment comprises at least one of a reduction of fan speed, a reduction of air conditioning, or an increase of humidity.

3. The vehicle system of claim 2, wherein the increase of humidity results from recirculation deactivation.

4. The vehicle system of claim 1, wherein the air system setting adjustment comprises at least one of an adjustment of a window, a redirection of airflow away from the vehicle occupant, or a redirection of airflow towards the vehicle occupant.

5. The vehicle system of claim 1, wherein the logic device is configured to detect at least one of a capillary action in an eye of the vehicle occupant or a reflectivity of the eye of the vehicle occupant.

6. The vehicle system of claim 1, further comprising a GPS module configured to identify a location of the vehicle, wherein the air system setting adjustment is identified based on the location of the vehicle.

7. The vehicle system of claim 1, further comprising a weather module configured to acquire weather data, wherein the air system setting adjustment is identified based on the weather data.

8. The vehicle system of claim 1, further comprising a powertrain module configured to determine a vehicle economy, wherein the air system setting adjustment is identified based on the vehicle economy.

9. A vehicle comprising:
the vehicle system of claim 1; and
a heating, ventilation, and air condition (HVAC) system configured to adjust an air system setting of the vehicle based on the air system setting adjustment identified by the air system module.

10. A vehicle comprising:
a camera configured to capture one or images of a vehicle occupant;
a logic device configured to detect an eye condition of the vehicle occupant based on the one or more images captured by the camera; and
a heating, ventilation, and air condition (HVAC) system configured to adjust an air system setting of the vehicle based on the eye condition detected by the logic device.

11. The vehicle of claim 10, wherein the eye condition comprises a tear film breakup of an eye of the vehicle occupant.

12. The vehicle of claim 11, wherein the HVAC system is configured to adjust at least one of a fan speed, an air recirculation mode, or air conditioning of the vehicle to reduce the tear film breakup.

13. The vehicle of claim 11, wherein the logic device is configured to detect at least one of a capillary action in an eye of the vehicle occupant or a reflectivity of the eye of the vehicle occupant to detect the tear film breakup.

14. The vehicle of claim 10, wherein the eye condition comprises an indication of an allergic reaction of the vehicle occupant.

15. The vehicle of claim 14, wherein the air system setting comprises at least one of a window adjustment, a recirculation activation, or a particle filter activation.

16. The vehicle of claim 10, wherein the camera comprises an infrared camera.

17. A method comprising:
capturing, using a camera, one or more images of an occupant of a vehicle;
detecting a tear film breakup of the occupant based on the one or more images captured by the camera; and
adjusting an air system setting of the vehicle based on the detecting the tear film breakup of the occupant.

18. The method of claim 17, wherein the capturing comprises capturing one or more images of the occupant using an infrared camera.

19. The method of claim 17, wherein the detecting the tear film breakup comprises detecting at least one of a capillary action in an eye of the occupant or a reflectivity of the eye of the occupant.

20. The method of claim 17, wherein the adjusting the air system setting comprises at least one of turning off air conditioning, turning off a recirculation mode, or reducing a fan speed of a heating, ventilation, and air condition (HVAC) system of the vehicle.
